(19) United States
(12) Patent Application Publication
(10) Pub. No.: US 2010/0058245 A1
(43) Pub. Date: Mar. 4, 2010

(54) METHOD AND APPARATUS FOR AN OBJECT ORIENTED ON-SCREEN DISPLAY MENU SYSTEM WITH A VISUAL CUE

(76) Inventor: Takaaki Ota, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/200,848

(22) Filed: Aug. 28, 2008

(51) Int. Cl. G06F 3/048

(52) U.S. Cl. 715/841

(57) ABSTRACT

One embodiment provides a method and apparatus for an object oriented on-screen display menu system with a visual cue. The method includes the identification of an on-screen visual cue that is generated by an access device such as, for example, a digital television system. The on-screen visual cue display may also be generated by an access device, such as a set-top box, in response to a remote control command. Once detected, the on-screen visual display may be used to identify an object of focus within the on-screen display in response to a menu selection event. In one embodiment, the remote control command is issued to the access device prior to a menu selection event. By using a visual cue to identify an object of focus, a context-dependent sub-menu is provided that corresponds to the identified object of focus to simplify user menu access. Other embodiments are described and claimed.

### COPYRIGHT NOTICE PER 37 CFR 1.71(e)

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. All trademarks used herein are the property of their respective trademark owners.

### FIELD

The invention relates generally to the field of digital television systems. More particularly, one or more of the embodiments relate to a method and apparatus for an object oriented on-screen display menu system with visual cue.

### BACKGROUND

The majority of US households receive television content through a service provider, such as terrestrial broadcast, cable, and direct broadcast satellite (DBS) companies. Such systems traditionally use a few OEM suppliers of hardware (e.g., set top boxes) and do not provide for integration of functionality of set-top boxes directly into digital TV sets. Direct broadcast satellite or DBS companies can broadcast multimedia, platform-specific applications, possibly together with digital television programs. A suitably-equipped multimedia platform-specific set-top box can receive these applications and run them locally. Example applications are: electronic program guides, play-along games, telebanking, teleshopping, electronic newspapers and similar information services.

However, digital television or DTV OEMs have begun to include set-top box functionality directly in the digital televisions they manufacture. The DTVs provided from such OEMs also provide additional features which are geared toward improving a user's experience of broadcast multimedia data. To truly enhance a user's experience when viewing multimedia content, they require access to a menu system of the DTV to unlock the various features provided therein. Unfortunately, conventional menus are organized in a hierarchical manner as a single menu tree. This tree has a hierarchy that categorizes menu items with each menu item located somewhere down a hierarchical menu tree. Such a menu tree may include, for example, pictures, sound, clock/timer, settings or the like.

As an example, based on the categorization of the menu hierarchical tree, if a settings note appears before audio/video separation, there will be a separation somewhere beyond the setting. In addition, if picture and sound are separate menu items, each path may have its own setting down a different branch. As a result, finding a single menu item of a large tree with a deep hierarchy can prove cumbersome to a user.

### SUMMARY

One embodiment provides a method and apparatus for an object oriented on-screen display menu system with a visual cue. The method includes the identification of an on-screen visual cue that is generated by an access device such as, for example, a digital television system. The on-screen visual cue display may also be generated by an access device, such as a set-top box, in response to a remote control command. Once detected, the on-screen visual display may be used to identify an object of focus within the on-screen display in response to a menu selection event.

In one embodiment, a context-dependent sub-menu is determined for an object of focus. The object of focus may be determined according to an on-screen visual cue that is generated by an access device in response to a remote control command. In one embodiment, the remote control command is issued to the access device prior to a menu selection event. By using a visual cue to identify an object of focus, in one embodiment a context-dependent sub-menu is provided that corresponds to the identified object of focus to simplify user menu access.

### BRIEF DESCRIPTION OF THE DRAWINGS

The present invention is illustrated by way of example, and not by way of limitation, in the figures of the accompanying drawings and in which:

FIG. 1 is a block diagram of a set top box (STB) access device and a digital TV control device that provides an object-oriented on-screen display menu with a visual cue, according to one embodiment.

FIG. 2 is a block diagram of an STB access device that provides an object-oriented on-screen display menu with a visual cue, according to one embodiment.

FIG. 3 is a block diagram of a digital TV control device that provides an object-oriented on-screen display menu with a visual cue, according to one embodiment.

FIG. 4 is an example of an electronic program guide (EPG) screen for identifying an object of focus for providing a context-dependent sub-menu according to one embodiment.

FIG. 5 is an example of a detail page in an EPG for identifying an object of focus for providing a context-dependent sub-menu according to one embodiment.

FIG. 6 is an example of an on-screen display generated in response to a channel change for identifying an object of focus for providing a context-dependent sub-menu according to one embodiment.

FIG. 7 is another example of an on-screen display that is generated in response to a channel change for identifying an object of focus for providing a context-dependent sub-menu according to one embodiment.

FIG. 8 is an example of an on-screen display that can be generated by a set top box in response to an information command issued by a digital television for identifying an object of focus for providing a context-dependent sub-menu according to one embodiment.

FIG. 9 is a flow chart depicting a method for an object oriented on-screen display menu system with a visual cue, according to one embodiment.

FIG. 10 is a block diagram illustrating a content delivery system to provide an object oriented on-screen display menu system with a visual cue, according to one embodiment.

### DETAILED DESCRIPTION

A method and apparatus for an object oriented on-screen display menu system with a visual cue are described. As described in greater detail below, in certain embodiments a control device uses menu selection events to identify an object of focus within an on-screen display of a digital television. As described herein, the term “object of focus” may include an object that corresponds to an on-screen visual cue that is generated by an access device or the like. As described herein, the term “an on-screen visual cue” is a visual image or on-screen display that is generated by an access device in response to a remote control command issued to the access device prior to the menu selection event.

As described herein, the term “menu selection event” includes, but is not limited to, a menu request issued by a user in response to a remote control command. As described herein, a “remote control command” may include a user issued command that causes the display of some visual information that may identify an object of focus within an on-screen display. By identifying an object of focus within an on-screen display in response to a menu selection event, a context-dependent sub-menu for the object of focus provides simplified menu access.

In the embodiments described, remote control command that are issued by a remote control device are monitored to detect an on-screen visual cue that is generated by an access device in response to a remote control command issued to the access device prior to a menu selection event. As described herein, remote control devices include, but are not limited to, hand-held battery operated controllers that are roughly five to ten inches in length and one to four inches wide and other like devices that use infrared (IR) and/or radio frequency (RF) transmissions to send encoded control messages to a target device such as a television, recorder, player, access device, set-top box, control device, etc. Currently, the most prevalent class of such devices use a numeric key pad along with dedicated command keys such as [ON], [MENU], [PLAY], [RECORD], [GUIDE], [SELECT], [LIST], etc. commands and keys representing channel and volume up and down incrementing commands.

As described herein, a “control device” may include but is not limited to television sets and other devices using or incorporating television receivers described herein including digital television sets, set-top boxes, set back boxes, digital video recorders, Blu-ray® recorders, optical disc recorders, disc drive recorders and other devices without limitation.

As described herein, the term “access device” is intended to mean a device such as a television set-top box or other terminal that has direct access to on-screen visual cues through digital data communication, whereas the term “receiver device” is generally intended to represent the device that receives video content from the access device, but is unable to directly access the digital representation. The receiver device, by virtue of becoming the master to the access device in accord with embodiments consistent with the present invention is also referred to as a control device.

In the following description, certain terminology is used to describe features of the invention. For example, the term “logic” is representative of hardware and/or software configured to perform one or more functions. For instance, examples of “hardware” include, but are not limited or restricted to an integrated circuit, a finite state machine or even combinatorial logic. The integrated circuit may take the form of a processor such as a microprocessor, application specific integrated circuit, a digital signal processor, a micro-controller, or the like.

An example of “software” includes executable code in the form of an application, an applet, a routine or even a series of instructions. The software may be stored in any type of computer or machine readable medium such as a programmable electronic circuit, a semiconductor memory device inclusive of volatile memory (e.g., random access memory, etc.) and/or non-volatile memory (e.g., any type of read-only memory “ROM”, flash memory), a floppy diskette, an optical disk (e.g., compact disk or digital video disc “DVD”), a hard drive disk, tape, or the like.

A further example of software includes a “software module.” A “software module” or “module” is a series of code instructions that, when executed, performs a certain function. Examples of such code include an operating system, an application, an applet, a program or even a subroutine. Software module(s) may be stored in a machine-readable medium, including, but not limited to, an electronic circuit, a semiconductor memory device, a read only memory (ROM), a flash memory, an erasable ROM (EROM), a floppy diskette, a computer disk, an optical disk, a hard disk, a fiber optic medium, a radio frequency (RF) link and the like.

The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

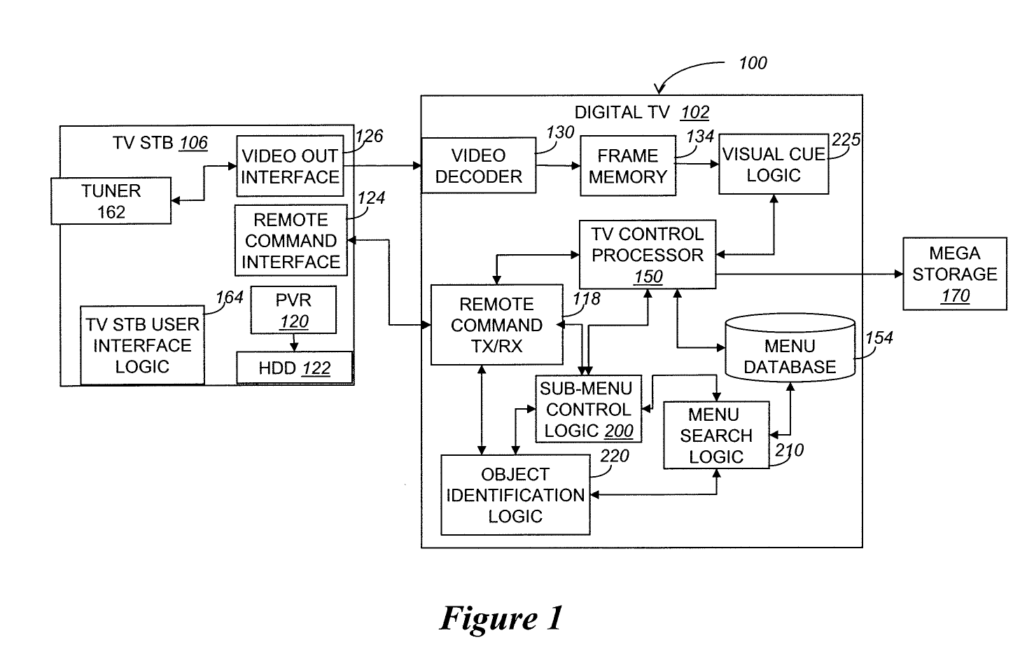

FIG. 1 is a block diagram of a STB access device 106 and a digital TV control device 102 that provide an object oriented on-screen display menu system with a visual cue according to one embodiment. As shown in FIG. 1, STB 106 may include a service provider personal video recorder (PVR) 120. Conventionally, service provider PVRs such as PVR 120 seem to run out of free memory space on hard disk drives (HDD) 122 for storing content selected by a user.

As further illustrated in FIG. 1, digital TV 102 may include personal video recorder capabilities such as provided by mega storage 170 which may include one or more storage mediums such as one or more Blu-ray® discs by Sony Electronics®, Inc. of Parkridge, N.J. In one embodiment, object identification logic 220 and sub-menu control logic 200, in combination with menu search logic 210, identify an object of focus within an on-screen display in response to a menu selection event. In one embodiment, the object of focus is identified according to an on-screen visual cue that is generated by an access device in response to a remote control command. In a further embodiment, digital TV 102 provides archival functions for recording content within mega storage 170 such as programs contained within HDD 122 to provide additional space within HDD 122. In a further embodiment, digital TV 102 may transfer shows from HDD 122 to mega storage 170 such as digital video disc, Blu-ray disc or other like persistent storage medium.

Representatively, FIG. 1 illustrates that digital TV 102 is connected to a cable set-top box 106 serving as an access device for receipt of digital content from a service provider. As described herein, a “service provider” may refer to a company that broadcasts digital content to a plurality of digital televisions that may or may not include set-top boxes, including, but not limited to terrestrial broadcast, cable, and direct broadcast satellite (DBS) companies, and the like. A user may tell the STB access device 106 to cycle through channels by sending IR or RF remote control commands to enable program selection for viewing on TV 102.

In one embodiment, TV 102 issues commands using remote command transmitter/receiver (TX/RX) 118 that are received by a remote command interface 124. This results in STB 106 generating a display of the EPG that is sent via the video output interface 126 to a video decoder 130. The video frame representing the EPG is then displayed and captured in a frame memory 134 of the digital TV 102. In one embodiment, sub-menu control logic 200 monitors the commands issued to STB 106 to detect an on-screen visual cue that is generated by an access device in response to a remote control command issued to the access device prior to the menu selection event. Once object identification is carried out, the resulting information is used to search menu database 154, and to identify a context-dependent sub-menu for the object of focus using menu search logic 210 and object identification logic 220.

Referring again to FIG. 1, in the embodiments described, operation of the process is independent of the nature of the access device so long as the receiver device such as 102 can use some mechanism to detect an on-screen visual cue that is generated by an access device in response to a remote control command issued to the access device prior to the menu selection event.

In one embodiment, an on-screen visual cue that is generated by an access device can thus allow the CE manufacturer's TV or other receiver device to provide an object oriented on-screen display menu system with a visual cue.

Remote control commands that cause an on-screen visual cue that is generated by an access device can be issued using any the following or any other suitable interface and control device:

1. IR or RF blaster

2. HDMI Consumer Electronics Control (CEC)

3. 1394 AVC using CEA 931B

4. Internet Protocol

The following are the minimum remote control Keycode set required by OCAP for Cable:

Hot Buttons: [Guide], [Cancel], [Select], [List], [Power], [Info], [Menu], [Exit], [Last], [Function 0-3][Favorite],[Next Favorite], [On Demand]

Tune: [Channel Up], [Channel Down], [RF Bypass]

Sound: [Volume Up], [Volume Down], [Mute]

Arrows: [Up], [Down], [Left], [Right]

Page: [Up], [Down], [Left], [Right]

10-key: [0,1,2,3,4,5,6,7,8,9 and multiple digit combinations]

Trick Play: [Fast forward], [Pause], [Rewind], [Skip Forward], [Skip Back], [Stop], [Play], [Record]

These are the basic set that most remote controls support. Not listed by the OCAP specification were: [Pip] and [Swap].

Referring again to FIG. 1, a remote command transmitter may be any suitable transmitter that is compatible with a receiver within access device 106 such as an infrared or RF transmitter 118 similar to that used in an STB remote control. Visual cue logic provides an output that is indicative of the presence of an on-screen visual cue that is generated by an access device.

Acquiring a context-dependent sub-menu for the object of focus according to an on-screen visual cue that is generated by an access device as described above can be accomplished real-time as a user selects content from, for example, a service provider EPG or PVR menu of recorded content. Accomplishing this real time, in accord with certain embodiments, utilizes an ability of the control device to understand the control codes for multiple devices (e.g., a PVR and the DTV control device 102).

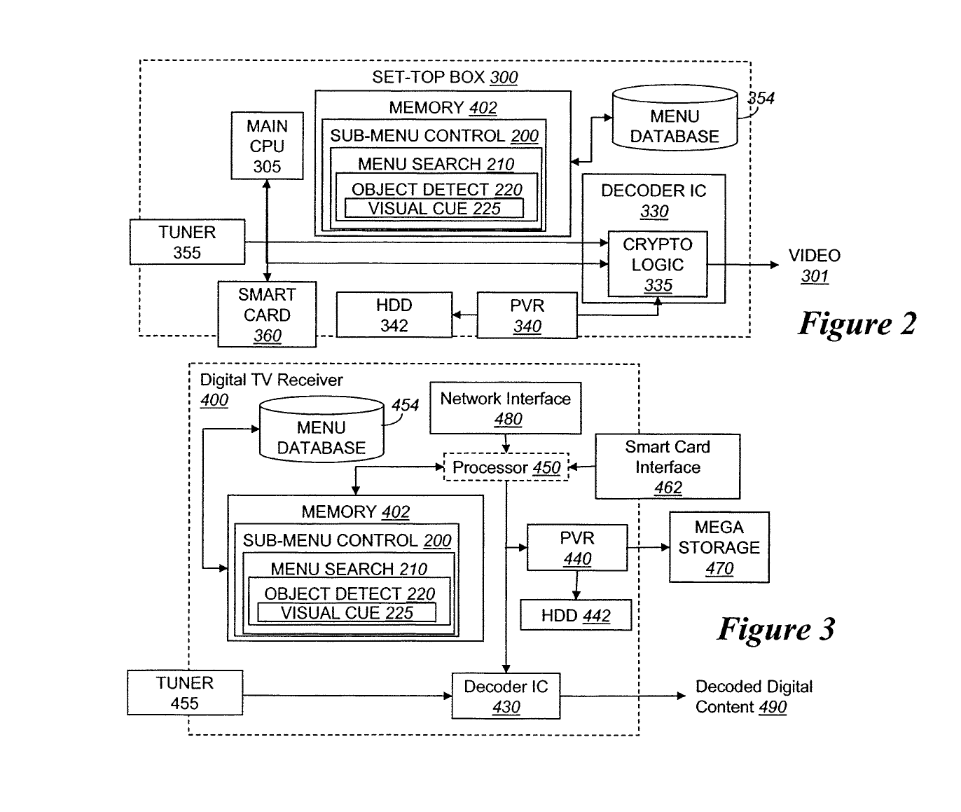

FIG. 2 is a block diagram illustrating a secure content delivery system that includes a set-top box 300 adapted to operate with a sub-menu control 200 to provide an object oriented on-screen display menu system with a visual cue, in accordance with one embodiment. Representatively, FIG. 2 is a block diagram of a STB access device 300 that obtains a context-dependent sub-menu for the object of focus according to an on-screen visual cue that is generated by an access device according to one embodiment. As shown in FIG. 2, STB 300 may include a service provider personal video recorder (PVR) 340 and hard disk drives (HDD) 342 for storing content selected by a user. As shown in FIG. 2, set-top box 300 may include a main CPU 305 which in conjunction with smart card 360 and tuner 355 may direct a decoder integrated circuit 330 and cryptographic logic 335 to decode received digital content to provide video 301. As further shown in FIG. 2, a personal video recorder or PVR 340 may store encrypted content within hard disk 342.

In one embodiment, the features of set-top box 300 may be incorporated within digital TV receiver 400 as shown in FIGS. 2 and 3. Representatively, a digital receiver includes a network interface 480 as well as processor 450 which directs decoder 430 to provide decoded digital content 490 from tuner 455. In the embodiment described, the sub-menu control is provided as a software module which is loaded within memory 402 according to one embodiment.

As illustrated in FIG. 3, digital receiver 400 may include personal video recorder capabilities such as provided by mega storage 470 which may include one or more storage mediums such as one or more Blu-ray® discs by Sony Electronics®, Inc. of Parkridge, N.J. In one embodiment, PVR 440 enables digital TV 400 to directly record to digital video disc, Blu-ray® disc or other like storage device for directly recording programs for set-top boxes or STBs that do not include a PVR such as PVR 440.

Referring again to FIGS. 2 and 3, in the embodiments described, operation of the process is independent of the nature of the access device so long as the receiver device such as digital TV 400 includes a system layer for loading sub-menu control 200. In one embodiment, an on-screen visual cue that is generated by an access device in response to a remote control command issued to the access device prior to the menu selection event enables an object oriented on-screen display menu system with a visual cue. In such a scenario, an object of focus identified by sub-menu control 200 allows the CE manufacturer's TV or other receiver device to provide an object oriented on-screen display menu system with a visual cue.

Hence, by recognition of multiple remote commands, a monitoring device (i.e., control device such as a DTV) attached to a player/receiver, e.g. Sony TV, including sub-menu control 200 and menu search 210, can track the state of the receiver by monitoring remote control commands sent to that receiver by the user to provide a context-dependent sub-menu for the object of focus. The control device therefore interprets not only its own remote control codes but also that of the receiver. The keystrokes may be monitored separately to identify an object of focus within an on-screen display.

By monitoring the keystrokes sent by the user to the receiver, the monitoring device can tell whether the receiver is doing the following: 1) accessing PVR content; 2) accessing the menu screen; 3) accessing the guide, 4) selecting a field which could be content, a sub-menu or other function from the menu, PVR or guide; 4) determining whether trick mode functions such as play, fast forward/reverse, skip forward/reverse, etc. are being used which would be indicative of PVR or VOD content is being accessed.

In accordance with certain embodiments, the control device can determine that another device has been switched-off because the control device detected that the receiver “power” button has been pressed. If the TV input is not switched to other content (another port), then after some time, the TV itself could be switched-off. This might help the TV to be more energy efficient.

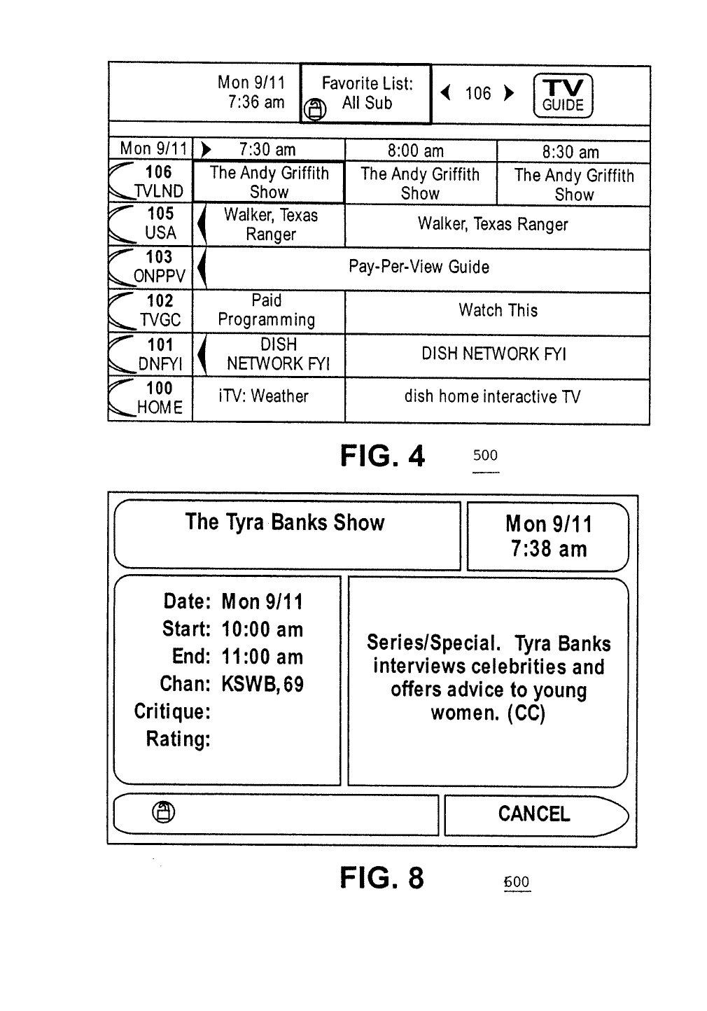

In one embodiment, the on-screen visual cue is generated by an access device when content is selected from an Electric Program Guide or EPG. In one embodiment, remote control commands are passed through from the recorder to the set top box using IR blaster or CEA-931B. When the set top box [GUIDE] button is pressed on the universal remote control, the recorder can become aware that the scheduled content is about to be browsed and chosen from the service provider EPG such as service provider EPG 500 as shown in FIG. 4.

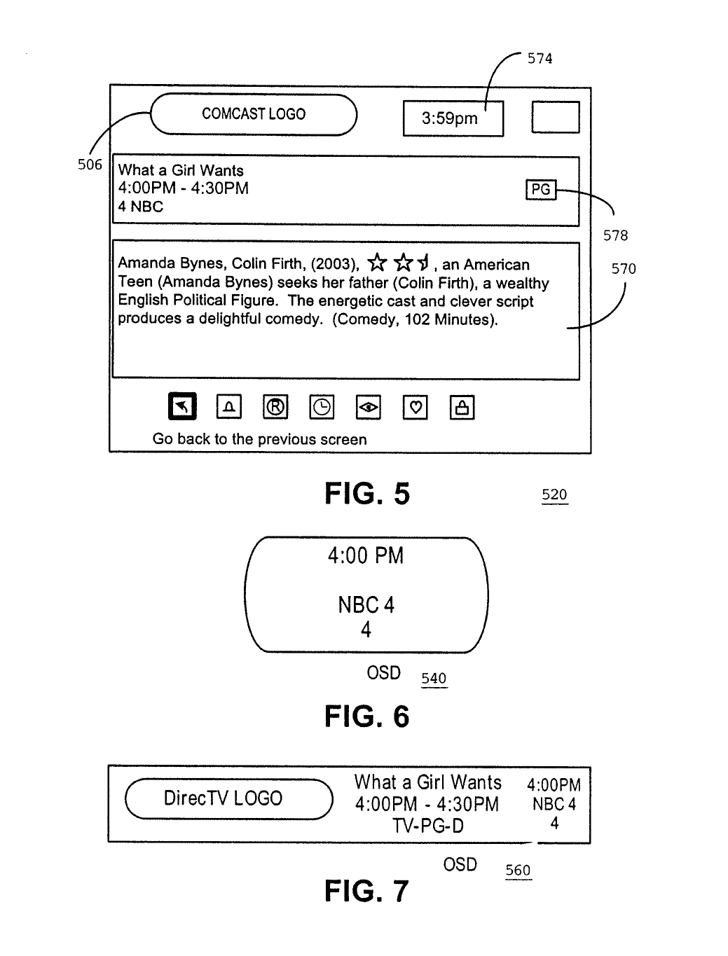

It is noted that in the United States, there are a limited number of service providers available, each of which uses a more or less conventional style of electronic program guide. Two examples are provided in FIGS. 4 and 5. FIG. 4 is a screen shot adapted from an EPG used by DISH Network™ (EchoStar Technologies Corporation) and FIG. 5 is an exemplary screen shot adapted from an information screen used by Comcast™ (Comcast Corporation). Actual screen shots and other attributes may be copyright or trademarks of their respective owners. It is noted that the metadata associated with the television programming schedule is, in both cases and indeed in most EPGs, presented in a spreadsheet-like format time and date increasing from left to right in half hour increments with the channel and its associated program content appearing in rows below or above the time information.

Commonly, an on-screen visual cue provides more detailed information about a particular program. Such information is commonly represented at least in part on the EPG screen itself for a program that is highlighted on the EPG. FIG. 4 illustrates an example where additional information is not provided. This information may be complete and represent the entire program detail (see FIG. 5), or may be abbreviated as shown in FIG. 4.

FIG. 7 is another example of an on-screen display that is generated in response to a channel change for identifying an object of focus for providing a context-dependent sub-menu according to one embodiment.

FIG. 8 is an example of an on-screen display that can be generated by a set top box in response to an information command issued by a digital television for identifying an object of focus for providing a context-dependent sub-menu according to one embodiment.

However, some users are in the habit of merely toggling the up and down arrow buttons of a remote control to select a desired program, rather than accessing an EPG such as EPG 500 as shown in FIG. 4. For example, according to the DIRECTV® system of DIRECTV® of El Segundo, Calif., depending on the mode of the set top box, in response to a channel change by a user by toggling the up and down arrows of a remote control, the set top box may cause the generation of an on-screen display such as OSD 540 as shown in FIG. 6.

Referring again to FIG. 4, when a user selects a program using the EPG 500, generally there will be a certain number of right and left arrows, paging up and down until finally the [SELECT] or [CANCEL] button is pressed. Both commands, [SELECT] and [CANCEL], are intercepted by remote command receiver 118 as shown in FIG. 1. In one embodiment, when the [SELECT] command is used, the user has just attempted to choose some content. When the content is already being broadcast, then the content would be immediately tuned by the receiver, with an OSD displayed depending on the mode of STB 106. Otherwise, a timer may be created.

Generally, the set top box may generate on-screen visual cues as the content is selected which may be used to identify an object of focus. The OSD generated by the set top box may provide a minimum amount of information including the system time, the channel from which the content is being provided and the name of the network, as shown in FIG. 6.

It is noted that no cooperation from the service provider is needed to carry out the processes described and no outside data source is needed (although use of an outside data source to augment the information captured as described is not precluded). Embodiments consistent with the invention display a context-dependent sub-menu for the object of focus according to an on-screen visual cue that is generated by an access device in response to a remote control command issued to the access device prior to the menu selection event.

Moreover, embodiments may be utilized to communicate through video with no dedicated back channel. The embodiment disclosed does require a mechanism to control the operation of the access device, e.g. an IR transmitter to transmit commands, but then the information received is sent only as a video representation. Hence, in some embodiments, an unsightly set top box access device could even be totally hidden from view and controlled by a control device such as 106 using any suitable command mechanism. Although discussed in terms of infrared RC codes, IR may be replaced by RF signaling. Multiple RF frequencies may be monitored or multiple codes within a single RF frequency may be monitored. Procedural methods for implementing one or more embodiments are now described.

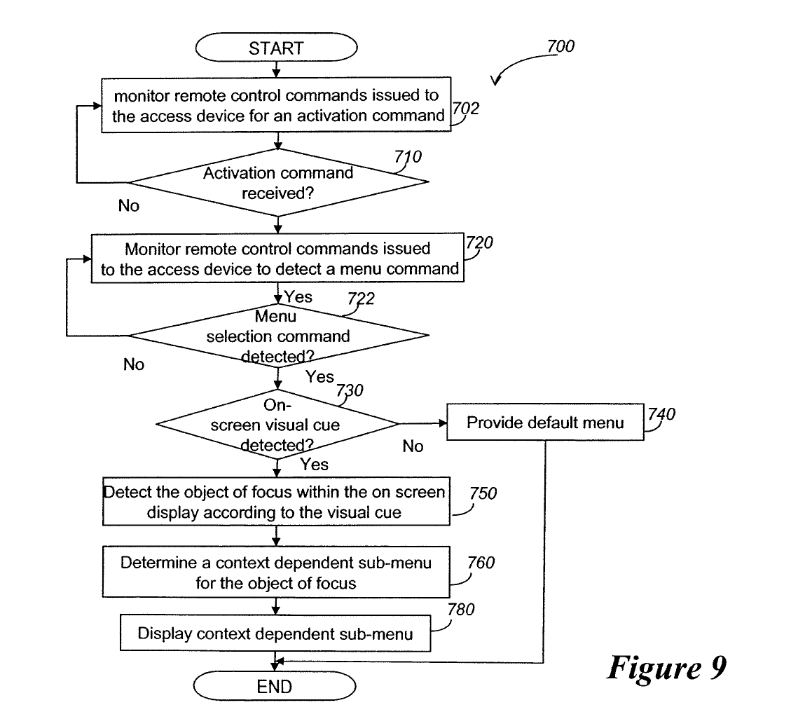

Turning now to FIG. 9, the particular methods associated with various embodiments are described in terms of computer software and hardware with reference to a flowchart. The methods to be performed by a computing device (e.g., a digital TV device) may constitute state machines or computer programs made up of computer-executable instructions. The computer-executable instructions may be written in a computer program and programming language or embodied in firmware logic. If written in a programming language conforming to a recognized standard, such instructions can be executed in a variety of hardware platforms and for interface to a variety of operating systems.

In addition, embodiments are not described with reference to any particular programming language. It will be appreciated that a variety of programming languages may be used to implement embodiments as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 9 is a flowchart illustrating a method 700 of an object oriented on-screen display menu system with a visual cue according to one embodiment. FIG. 9 depicts process 700 that can be used to obtain a real time, context-dependent sub-menu for an object of focus according to an on-screen visual cue that is generated by an access device in accordance with one embodiment. A use for this embodiment involves acquiring an on-screen visual cue that is generated by an access device in response to a remote control command issued to the access device prior to a menu selection event. This is accomplished with a search of a menu database to display the context-dependent sub-menu corresponding to the identified object of focus.

Referring again to FIG. 1, in this process, the remote control commands issued to receiver 118 are monitored by control logic 200. (Note that the PVR 120 could readily be a part of DTV 102 without departing from the described embodiments, and the term “accessory device” should not be construed to exclude internal accessory devices.) Referring again to FIG. 9, the remote control commands are monitored first for an activation command (e.g., the PVR is being turned on or selected) at 702 (here the term activation command can be construed to be an equivalent sequence of commands such as a menu command followed by a guide command selection from the menu, without limitation—i.e., a command or sequence of commands that that activates a mode of operation having potential for selection of a program activates a mode of operation having potential for selection of a program).

Once the activation command is received at 710, the RC commands issued to an access device are monitored for a [MENU] command at 720. Issuance of such a command (without the command being preceded by an off command) is indicative that a menu item has been selected for some issue (e.g., playback, recording, browsing, etc.). At this point, when a [MENU] command is received at 722, the control device 102 determines an OSD that is temporarily displayed at 730. Detection of an OSD visual cue results in identification of an object of focus within an OSD at process block 750.

In one embodiment, a visual OSD generated in response prior to a menu selection event enables the search of a menu database to provide a context-dependent sub-menu for the identified object of focus. At process block 760 the context-dependent sub-menu is displayed. Note that in alternative embodiments, any signal that is indicative of a menu selection event can be harnessed as a trigger to issue an [INFO] command. Additionally, the control device 102 can readily render an on-screen display to ask the user if he or she desires a context-dependent sub-menu for the identified object of focus. Many other variations are possible without departing from embodiments consistent with the present invention.

In the embodiments described where a menu selection event is detected, the amount of metadata that can be captured and decoded from an on-screen display to identify an object of focus according to a visual cue that is generated by the set top box in response to a remote command may provide a minimum amount of metadata to determine an object of focus. (See, FIG. 6.) Using such information at process block 780, the context-dependent sub-menu is displayed for the identified object of focus.

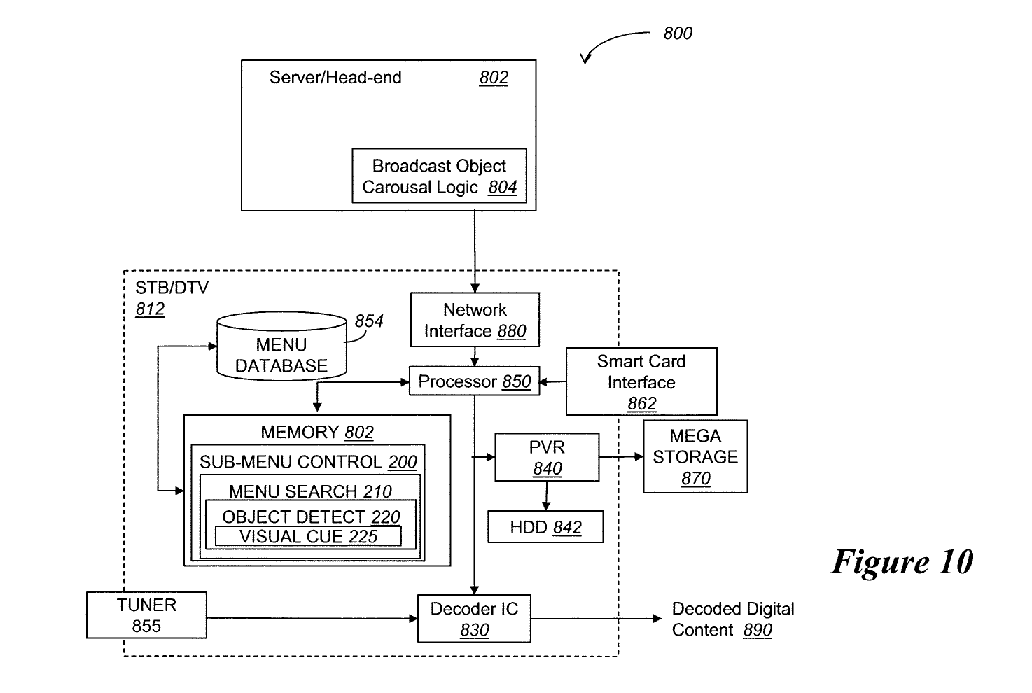

FIG. 10 is a block diagram illustrating a content delivery system 800 including a server/head-end 802. Representatively, server 802 includes broadcast object carousel logic 804 for broadcasting an object carousel including program broadcast digital content. The broadcast object carousel is received by a set-top box/digital TV system (STB/DTV) 812. STB/DTV 812 includes similar reference numerals to set-top box 300 and digital TV receiver 400 shown in FIGS. 2 and 3. In one embodiment, as shown in FIG. 10, a home network may be coupled to STB/DTV 812 as well as mega storage 870 which provides or supplements content recording capabilities provided by HDD 842.

To further summarize, the remote control keypresses are monitored. Whenever, for example, [GUIDE] or [PVR] or [ON] or [LIST] for a PVR are pressed (note that it is not inconsistent for these commands to be issued to the STB 106 which may or may not incorporate a PVR), monitoring commences. [UP], [DOWN], [PAGE UP], [PAGE DOWN] and other keys are pressed by the user until finally [SELECT] is pressed.

Thus, a method of capture of a context-dependent sub-menu in near real time consistent with certain embodiments involves monitoring remote control commands to detect an activate command that activates a mode of operation having potential for selection of a menu request; upon receipt of the activate command, further monitoring remote control commands for a selection command that causes an access device to generate an OSD with a visual cue; upon receipt of the selection command, detect an object of focus corresponding to the visual cue that an access device generates in response to a remote control command; and searching a menu database to identify a context-dependent sub-menu for the object of focus.

In another embodiment, a control device provides a context-dependent sub-menu for the object of focus in near real time and has a control processor that controls a process wherein a remote control command receiver monitors remote control commands to detect an on-screen visual cue that is generated by an access device. Upon detection of an object of focus, the remote control command further monitors remote control commands for a menu selection command. Upon receipt of the menu selection command, an on-screen display is generated by an access device that represents a context-dependent sub-menu for the object of focus.

However, the described embodiments are not to be considered to be limited to the exact command structure or command sequence structure that are used in the remote control paradigm used in such conventional remote controller devices. Equivalently, television devices that are more computer based may utilize a point and click paradigm for navigation of menus to issue equivalent commands. So, a mouse, trackball, touch pad or other pointer device used in conjunction with a selection mechanism (e.g., a right or left click of a dual switch mouse) can produce equivalent set of commands and are entirely equivalent for purposes of defining embodiments consistent with the present invention.

Thus, playback from a PC device using Microsoft Windows Media Player might include a sequence of operations including pointing to a Windows Media Player icon, clicking on the icon, pointing to a “Library” tab and clicking on the “Library” tab, pointing to an “all video” menu selection and clicking, followed by pointing to a video selection and clicking. Such a paradigm generally includes action of a pointing device to point followed by clicking a pointer select button to implement a selection operation.

Thus, in a similar manner, if a user is to implement a [MENU] or [GUIDE] command using such a point and click paradigm, the operation would involve manipulation of an on-screen cursor to a desired menu location (icon, text, logo, image, thumbnail, etc.) representing a [MENU] or [GUIDE] function followed by an operation that selects the command associated with the cursor location. For purposes of embodiments of this invention, this sequence of operations is intended to be embraced in its entirety by the shorthand notation of [MENU] or [GUIDE] without regard for how such sequence of commands are implemented.

At this writing, cursor movements have been implemented using any number of functions including detection of wrist or hand motion using inertial detectors, sometimes in connection with detection of gravitational force as an up-down reference point. Movement to a particular cursor location (e.g., an edge or corner of the screen) can be used to invoke a particular menu. An example of such devices is produced by Hillcrest Laboratories, Inc. of Rockville, Md. which uses a scroll wheel and select buttons in conjunction with motion sensing technology (referred to as Spontaneous Navigation™) configured in a circular doughnut shaped device that is hand held. In this device, navigation is carried out by movement of the hand or wrist, and such movements are used in cooperation with selection buttons and a scroll wheel. However, this paradigm is but a newer incarnation of point and click functions that use different hand motions than those, for example, of a computer mouse.

Hence, in summary, when bracketed commands such as [ON], [MENU], [LIST] or [GUIDE] are used herein, it is to be understood that equivalent functions can be carried out by point an click interfaces or other user interface paradigms without departing from the teachings consistent with embodiments of the present invention. Such point and click implementations are functionally identical and within the scope of the present claims in that any command that implements the bracketed command will produce a visual that can be interpreted by to identify an object of focus within an OSD.

### Alternate Embodiments

Several aspects of one implementation of an object oriented display menu system with a visual cue are described. However, various implementations of the object oriented display menu system with a visual cue provide numerous features including, complementing, supplementing, and/or replacing the features described above. Features can be implemented as part of the DTV or as part of a home entertainment network in different embodiment implementations. In addition, the foregoing description, for purposes of explanation, used specific nomenclature to provide a thorough understanding of the embodiments of the invention. However, it will be apparent to one skilled in the art that the specific details are not required to practice the embodiments of the invention.

It is to be understood that even though numerous characteristics and advantages of various embodiments have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments. Changes may be made in detail, especially matters of structure and management of parts within the principles of the embodiments to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A method comprising:
identifying an object of focus within an on-screen display in response to a menu selection event;
determining a context-dependent sub-menu for the object of focus according to an on-screen visual cue that is generated by an access device in response to a remote control command issued to the access device prior to the menu selection event; and
displaying the context-dependent sub-menu corresponding to the identified object of focus.

2. The method of claim 1 further comprising:
recording the on-screen visual cue generated by the access device in response to a remote control command issued to the access device.

3. The method of claim 1, wherein determining the object of focus further comprises:
monitoring remote control commands issued to the access device to detect a menu command;
upon detection of the menu command, determining whether a visual cue is present within the on-screen display; and
detecting the object of focus within the on-screen display according to the visual cue if a visual cue is detected.

4. The method of claim 1, further comprising:
displaying an audio configuration menu if a volume bar visual cue is detected in response to the menu selection event.

5. The method of claim 1, further comprising:
displaying a program related menu if a title bar visual cue is detected in response to the menu selection event.

6. The method according to claim 3, carried out in a digital television device, wherein the digital television device is not a target device of the remote control.

7. The method of claim 1, further comprising:
displaying a parental control menu of a channel number visual cue is detected in response to the menu selection event.

8. The method of claim 1, wherein the access device comprises a television set top box that is a target of a remote control selection command, and wherein the process is carried out on a digital television device.

9. A computer readable storage medium storing instructions which, when executed on a programmed processor, carry out a process according to claim 1.

10. The method of claim 1, wherein the remote control command is one of a channel tuning event, a selection from a list of recorded programs on a personal video recorder (PVR), a selection from a list of Video on Demand (VOD) programs, a selection to play package media, a selection from a list of content stored on portable media, and a selection from a list of content stored on portable devices.

11. A method comprising:
detecting user activation of a menu button;
determining an object of focus corresponding to an on-screen visual cue that is generated by an access device in response to a remote control command;
determining a context-dependent sub-menu according to the visual cue that corresponds to the object of focus;
displaying the context-dependent sub-menu.

12. The method of claim 1, wherein detecting user activation comprises:
monitoring remote control commands issued to the access device to detect a menu command;
upon detection of the menu command, determining whether a visual cue is present on the on-screen display; and
determining whether a context-dependent sub-menu is available that corresponds to the object of focus determined according to the visual cue.

13. The method of claim 11, wherein the access device is not a target of the detected remote control command.

14. The method of claim 11, wherein detecting the remote control command further comprises:
monitoring remote control commands to detect a command that activates a visual cue on the on-screen display;
upon detection of the command, further monitoring remote control commands to detect a menu selection command; and
upon detection of the menu selection command, accessing a menu system to identify a context-dependent sub-menu corresponding to the visual cue.

15. The method of claim 11, wherein the visual cue is displayed on a remote commander.

16. A system comprising:
an access device including a remote control command receiver to detect a remote control command that activates a visual cue within an on-screen display in response to a menu selection event;
menu control logic to determine at least one context-dependent sub-menu that corresponds to an object of focus within the on-screen display, wherein the object of focus is identified according to the visual cue; and
a display logic to display the context-dependent sub-menu corresponding to the identified object of focus.

17. The system of claim 16, wherein the on-screen visual cue is generated by an access device in response to a remote control command issued to the access device prior to the menu selection event

18. The system of claim 17, wherein the access device comprises a set-top box that is a target of the remote control command that causes generation of the visual cue.

19. The system of claim 16, wherein the menu control logic further comprises:
menu search logic to search a menu database according to the identified object of focus to detect the context-dependent sub-menu for the identified object of focus.

20. The system of claim 16, wherein, upon detection of the remote control command that causes generation of the on-screen visual cue, the object identification logic detects the object of focus within the on-screen display that corresponds to the visual cue if a visual cue is detected.

21. The system of claim 16, wherein the digital television is not a target of the remote control command that causes generation of the on-screen visual cue.
